(19) United States
(12) Patent Application Publication
(10) Pub. No.: US 2005/0289503 A1
(43) Pub. Date: Dec. 29, 2005

(54) System for identifying project status and velocity through predictive metrics

(76) Inventor: Gregory Clifford, Tracy, CA (US)

Correspondence Address: William C. Milks, III;RUSSO & HALE LLP, 401 Florence Street, Palo Alto, CA, 94301, US

(21) Appl. No.: 10/881,542

(22) Filed: Jun. 29, 2004

(51) Int. Cl. G06F 9/44

(52) U.S. Cl. 717/101

(57) ABSTRACT

A development management system and method are disclosed for providing substantially real-time monitoring of the progress of a product development and a projection of completion of the project based on objective criteria, which can be plotted against the planned time to completion and budget for a project. The principle of the development management system and method as applied to a software product development is to perform detailed and empirically sound measurements of the source code, changes being made in code, defect measurements, and productivity measurements to build a highly accurate measurement of a project's status and velocity. The development management system and method also provide a real-time view, at a highly granular level, into the status and velocity of the project to enable projection of when the project will finish, what budget will be expected, and how each milestone of the project is progressing.

### BACKGROUND OF THE INVENTION

### Field of the Invention

The present invention relates generally to product development and methods for monitoring progress toward the completion of development of a product and, more particularly, to a system and method for product development management used in developing products and, hence, accurate reporting of the status of a product development project and prediction of the completion of the project. One preferred embodiment of the present invention provides an integrated system and method for predictive software development management of a software product including project velocity as a function of the completed tasks required to finish a project as a function of time and/or budget.

### REFERENCES

[1] Chidamber, S. R., and Kemerer, C. F., “A Metrics Suite for Object Oriented Design,” IEEE Trans Software Eng, 20 (6) 476-498.

[2] Chulani, S., Boehm, B., and Steece, B., “Bayesian Analysis of Empirical Software Engineering Cost Models,” IEEE Trans Software Eng, 25(4), 573-583, 1999.

[3] Cohn, M., “Empirical Evaluation of a Proposed Set of Metrics for Determining Class Complexity in Object Oriented Code,” University of Idaho, 1994.

[4] Fenton, N. E., and Neil, M., Software Metrics: A Rigorous Approach, Chapman and Hall, 1991.

[5] Fenton, N. E., and Neil, M., “Software Metrics: Roadmap” in The Future of Software Engineering (Editor: Anthony Finkelstein) 22nd International Conference on Software Engineering, ACM Press ISBN 1-58113-253-0, pp. 357-370, 2000.

[6] Halstead, M., Elements of Software Science, North Holland, 1977.

[7] McCabe, T., A Software Complexity Measure, IEEE Trans Software Eng, SE-2(4), 308-320, 1976.

[8] Zuse, H., Software Complexity: Measures and Methods, De Gruyter Gerlin, 1991.

### DESCRIPTION OF THE PRIOR ART

Today, one of the most intractable problems facing any business developing a product is that projects are consistently late, over budget, or have a set of features reduced from those originally planned. For example, it is unusual for a software development project to actually be delivered on the planned date, within the budgeted cost, and having the planned feature set.

Empirical studies by Gartner and Forrester show that up to 90% of all software development efforts are delivered late and/or over budget and/or are delivered with a reduced feature set. Of these software development projects, up to 25% were never actually completed or delivered.

The problem is so pervasive that project managers now actually expect their software development efforts to be late and often plan for that eventuality. There is no faith in the business world that their business critical software applications will be delivered on time. To most businesses, software development is a “black box” with very little visibility into the real-time status and progress of the project. This problem represents one of the largest challenges for modern businesses to increase productivity and manage costs.

The issue of understanding and managing the development project process has spawned dozens of industries to improve the development process. To date, the problem has not been adequately addressed.

More particularly, there are fundamental problems in the software development project process in predicting software development success. The process for determining the status and projected completion date of a software development project is poorly understood and unmanageable. In spite of over 40 years of software development experience, with highly sophisticated planning, coding, and architecture tools, and vast project management methodologies, the problem of late delivery, cost overruns, and defect prone software products persists.

Research and experience over the period spanning the last 40 years reveals several fundamental problems in managing software development. Creating working software is not a linear exercise like building a bridge or a building wherein all of the requirements for the project can be clearly defined at the inception of the project. Unlike a bridge or a building, it is difficult to identify all of the required parts that need to be purchased before hand and in what order they will be assembled.

Software development is typically a non-linear (often referred to as a “chaotic”) process with inherent properties of emergent behavior. Software development is extremely sensitive to initial conditions and change. Small changes in code can have unpredictably large consequences on the development effort. Understanding and measuring how a system of software code is interacting is fundamental to predicting when a project will complete, how much the project will eventually cost, and the quality of the completed product.

Historically, software development projects have been monitored using a fundamentally subjective approach. While modem project management tools are available to a project manager, ultimately the project manager must integrate his or her knowledge of the status of the project with subjective reports from the software development team to determine the overall status of the project. These subjective reports are inadequate for gaining timely visibility into the complexity of project management.

Many businesses have come to realize the inherently chaotic (non-linear) nature of software development. Businesses recognize that their development project processes must become less rigid and be able to quickly adapt to new business requirements and unexpected impediments for the projects to be successful.

A new paradigm of software development is emerging that emphasizes flexibility, adaptability, and accepts that issues will be encountered during the development project process. Smart businesses are changing the way they develop software to adapt to the complexity of these processes.

However, a significant problem remains: How does a software engineering team objectively measure the progress and health of their effort? Irrespective of the process involved, understanding the current status of a project in real time has proven to be elusive.

Thus, for all these reasons, it would be desirable to provide a development management system and method which overcome the above limitations and disadvantages of conventional subjectively based systems and techniques and provide an objective approach that can measure the status of a project and predictively estimate the completion of the project. It is to this end that the present invention is directed. The various embodiments of the present invention have many advantages over conventional project management methods and systems by providing solutions to measuring and predicting the status, progress, and success of a product development project, such as a software development project.

### SUMMARY OF THE INVENTION

One embodiment of the development management system and method in accordance with the present invention provides many advantages over conventional management systems and techniques, which make the development management system and method in accordance with the present invention more useful to product developers. One embodiment of the present invention provides a development management methodology and a system that provide an optimal solution to management of a development project, for example, a software development project.

A preferred embodiment of the development management system and method in accordance with the present invention provides a unique solution for enabling businesses to complete projects on time, on budget, and with a real-time view into the development effort. In accordance with an exemplary implementation of the preferred embodiment of the present invention, a development management system and method are provided to deliver a software product. Through measuring artifacts produced during software development, the exemplary embodiment of the development management system and method in accordance with the present invention provides unprecedented visibility into the actual progress of software development. The development management system and method in accordance with the present invention can predict with great accuracy, early in the development cycle, whether the project is viable and can estimate the expected completion date of the project.

Accordingly, the preferred embodiment of the development management system in accordance with the present invention provides a tool for objectively monitoring artifacts and measuring metrics used to forecast project completion versus schedule, and the method provides a technical advance in prediction of project completion over subjectively based project management systems and techniques. The development management system and method in accordance with one embodiment of the present invention dynamically collect the necessary data to produce metrics for processing to predict the completion of a project. The development management system accesses concrete data sources created during development and uses an expert reasoning subsystem to evaluate the current status and velocity of a project in real time.

The exemplary embodiment of the development management system and method in accordance with the present invention provides an objective and transparent view into software development efforts through harvesting the artifacts produced during software development such as Configuration Management Systems (e.g., CVS and ClearCase), Defect Management Systems (e.g., Bugzilla), Project Management Systems (e.g., Microsoft Project), and the source code itself. This delivers an unprecedented visibility into software engineering efforts. The course of the development project can be calculated as a function of time and/or budget and/or other parameter and plotted to provide a view referred to as project velocity.

In accordance with a further embodiment of the development project system and method of the present invention, a quality manager tool is provided to be used by executives, project stakeholders, project managers, and the engineering team itself for providing a real-time view, preferably at a highly granular level, into the status and project velocity of their software engineering projects. Preferably, the quality manager tool also pinpoints what specific code, what defects, which engineers, and what processes are causing a project to deviate from the planned completion date and/or budget. The quality manager may also suggest remediation tasks to bring the project back on track. This allows a highly accurate projection of when the project will finish, what ultimate budget is to be expected, and how each milestone of the project is progressing.

One preferred embodiment of the development management system in accordance with the present invention is implemented in C/C++ and available as software for Microsoft Windows®, several Linux distributions, and other operating systems. The development management system is easily integrated into existing environments and works with a centralized management layer.

Advantageously, the development management system and method in accordance with the present invention expertly reason the outcome of a software development effort in business terms. The development management system and method facilitate positive communications with, and responsive management of, local and remote software developers, in real time without interfering in the effort of the team. Managers gain insight, developers gain clarity, and the industry brings more product ideas to market.

The foregoing and other objects, features, and advantages of the present invention will become more readily apparent from the following detailed description of various embodiments, which proceeds with reference to the accompanying drawing.

### BRIEF DESCRIPTION OF THE DRAWING

The various embodiments of the present invention will be described in conjunction with the accompanying figures of the drawing to facilitate an understanding of the present invention. In the figures, like reference numerals refer to like elements. In the drawing:

FIG. 1 is a graph of project velocity showing progress on development over time and/or budget;

FIG. 2 is a block diagram of the development management system in accordance with one embodiment of the present invention;

FIG. 3 is a project setup screen displayed by the development management system in accordance with the embodiment of the present invention shown in FIG. 2;

FIG. 4 is a features editing screen displayed by the development management system in accordance with the embodiment of the present invention shown in FIG. 2;

FIG. 5 is a code tree screen displayed by the development management system in accordance with the embodiment of the present invention shown in FIG. 2;

FIG. 6 is an actual velocity diagram screen displayed by the development management system in accordance with the embodiment of the present invention shown in FIG. 2; and

FIG. 7 is metrics table screen displayed by the development management system in accordance with the embodiment of the present invention shown in FIG. 2.

### DETAILED DESCRIPTION OF THE PREFERRED EMBODIMENTS

The present invention is particularly applicable to computer software development projects, and it is in this context that the preferred embodiment of the present invention will be described. It will be appreciated, however, that the development management system and method in accordance with the present invention have greater utility, since they may be used for other types of development projects not specifically described herein. Accordingly, the embodiment of the development management system and method in accordance with the present invention as described in connection with a software development is an example only, and is not intended to limit the scope of the present invention to software development, as the principles of the present invention apply generally to monitoring the progress of development projects for any type of product.

Historically, the progress of a software development project, sometimes recently referred to as “project velocity,” has been determined through combining Lines of Code (LOC), project milestones, and subjective reports from the project team. LOC suffers from extreme oversimplification. Determining velocity from project milestones does not yield an accurate picture of the real-time status of the project. Status reports from team members are too subjective to provide a view into the current project.

Generally, the development management system in accordance with the various embodiments of the present invention provides substantially real-time monitoring of the progress of a product development and a projection of completion of the project based on objective criteria, which can be plotted against the planned time to completion and budget for a project. The principle of the development management system and method in accordance with the present invention as applied to a software product development is to perform detailed and empirically sound measurements of the source code, changes being made in code, defect measurements, and productivity measurements to build a highly accurate measurement of a project's status and velocity.

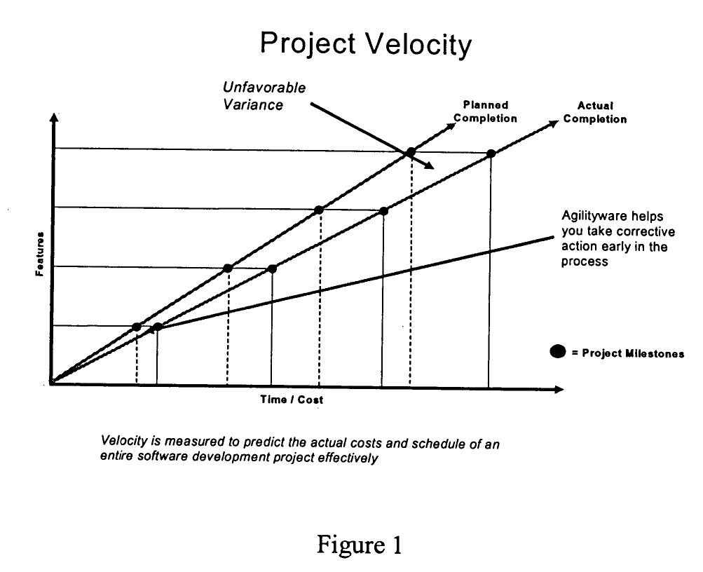

Accordingly, “project velocity” can be defined as the sum of the measurement of a set of objective software metrics deduced directly from the artifacts of a software development project plotted over time or budget, as shown in FIG. 1. Project velocity can provide a highly accurate estimation of the time to completion for a development effort.

The plot shown in FIG. 1 is an example of a Project Velocity Graph. The upper line shows the planned curve for the milestones and completion of the project. The development management system and method in accordance with the present invention can show as early as 25% into the project that the velocity is going awry. The lower line shows the projection by the development management system and method in accordance with the present invention. The user can click on the variance point on the graph and drill down into causes for the variance. The development management system and method in accordance with the present invention can display down to a class and method level, an engineering team or member, or specific defects with the metrics that caused the alert.

The value of project velocity is enormous. Having an accurate understanding of a project's velocity can enable project stakeholders and managers to very quickly respond to deviations from a project's schedule. Using the outdated model for project velocity based on simple statistics, project managers usually are not aware of deviations from project schedule in time to take corrective actions. The real-time measurement of project velocity in accordance with the development management system and method of the present invention based on objective metrics improves a development team's ability to deliver robust software on time and on budget by several factors.

By way of background, confronted with the perplexing problem that software products were consistently late and over budget, computer science began asking the question of how the quality and complexity of software products could be determined empirically. The question was asked: Is it possible by directly examining the artifacts of a software product development to make predictions about the quality of a software product?

The first attempts to measure the quality of software engineering using metrics were undertaken in the 1970's. It was discovered that Lines of Code (LOC) were a good guide to predicting the number of defects (bugs) in a software product. The reasoning was simple: more code equals more bugs. Lines of Code were also used to measure the productivity of software engineers. Again, more code equals more productivity.

Research from 1970 through the mid 1990's produced a great deal of investigation into software metrics, turning software metrics into a vigorous field of computer science with a strong empirical foundation. Until now, this research has been applied to software engineering primarily as a means of measuring the quality and maintainability of software.

In 2000, N. Fenton and M. Neil demonstrated that statistical and regression models of software engineering are not useful predictors of velocity and risk. They proposed applying the science of causal modeling to provide predictive analysis of software development projects.

Rather than determining quality, the development management system and method in accordance with the present invention apply software metrics to provide real-time predictions of software development project status and project velocity. The development management system and method then use causal modeling to provide a powerful means of analyzing those metrics to produce accurate results for project status and velocity.

“Software metrics” are defined as measurements created from the development and maintenance of software components, and can be related to any aspect of the process including timescales, usability, reliability, efficiency, portability, maintainability, and testability of software. See, [McCabe]. Software metrics involves the science of measuring the quality and complexity of the computer code and artifacts that comprise a software product. The development management system and method in accordance with the various embodiments of the present invention preferably focus on object oriented metrics and their use as predictors for software development project success.

Prior to the development management system and method in accordance with the present invention, software metrics have not been used as a predictive measurement of project velocity or to provide visibility into the progress of the software development process. Historically, software metrics have been used exclusively by engineering teams to analyze code complexity and defect probability. The development management system and method in accordance with the present invention use software metrics as a tool to build management decision support tools to enable project stakeholders and managers to make predictions and assessments in real time during the software development process.

The development management system and method in accordance with the present invention apply the science of software metrics to provide a real-time view into the status and progress of software development and make recommendations for remediation at a highly granular level. The development management system and method in accordance with the present invention provide insight from an individual method within a class, an individual defect, or for an individual engineer within a team up to the class and package level and the performance of the entire team.

Considered in more detail, the computer code contains artifacts that are harvested by the development management system and method in accordance with the present invention. Various metrics are generated from the artifacts by the development management system and method in accordance with the present invention. For example, the development management system and method in accordance with the present invention generate a plurality of metrics from project artifacts. Many of the metrics generated by the development management system and method in accordance with the present invention are based on established computer science. Some of the established metrics generated by the development management system and method in accordance with the present invention include: 1) McCabe's cyclomatic complexity; 2) Halstead metrics, including a) program length and b) programming error; 3) depth of inheritance tree; 4) code fan-in and fan-out; 5) lack of cohesion of methods; 6) response for a class; 7) number of children; 8) defect inflow; 9) defect outflow; and 10) defect recidivism. These metrics are well-known to persons skilled in the art and will not be described in detail. It is also contemplated that other metrics known to persons skilled in the art and that become known in the future can be used.

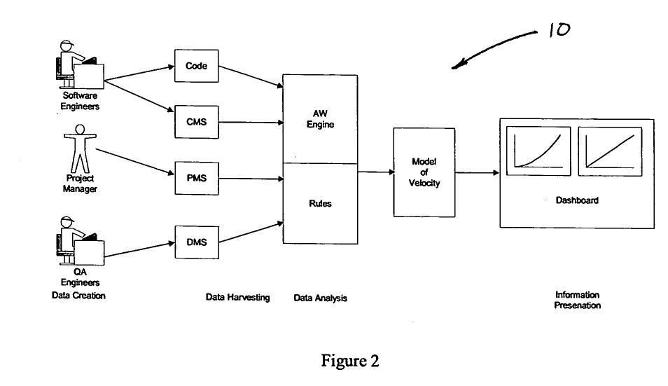

One embodiment of the development management system in accordance with the present invention, generally indicated by the numeral 10, is shown in FIG. 2. The development management system and method in accordance with the present invention use metrics to evaluate project status and determine project velocity. Generally, as shown in FIG. 2, there are three steps to the development management method in accordance with the present invention. Considered in more detail, the method of development product management in accordance with one embodiment of the present invention will now be described. These three steps are 1) data harvesting through application program interfaces; 2) data analysis using an engine; and 3) information presentation through visualizations.

Data harvesting is performed as follows. In order to produce objective and empirical measurements for a software development project, the development management system 10 goes directly to the artifacts produced during code development and gathers carefully selected data from those artifacts. The typical artifacts produced during software development include: 1) Configuration Management Systems (e.g., CVS and ClearCase); 2) Defect Tracking Systems (e.g., Bugzilla); 3) Project Management Systems (e.g., Microsoft Project); 4) Architecture Modeling Systems (e.g., Rational); and 5) Software Source Code (e.g., Java). The data points selected for examination are determined empirically based on evaluating the mechanics of software development and leveraging the maturing science of software metrics and measurement.

The development management system 10 can work with projects that are already well under way or with projects in the planning stages. For projects that are already in progress, the development management system 10 has the capability of examining the entire history of changes for the code of a project and gathering artifacts. Metrics are generated upon reconstructing the code base at user selectable intervals. These metrics are then input to the development management system 10 engine for processing. The development management system 10 uses this rich history and data to produce project velocity predictions, trends analysis, risk factors, and suggested risk remediation.

The project's historic data are used as the baseline for ongoing monitoring and reporting of the project. The development management system 10 produces real-time metrics and information as described in detail below.

For projects that have just entered the development effort, the development management system 10 first creates a baseline snapshot of the code base and all other development artifacts. As artifacts are changed during product development, metrics are updated in real time. The visual displays and other notification systems such as pagers are updated as the metrics change. This provides a real-time view of the status and velocity of the project.

The metric analysis performed by the development management system 10 will now be described. The heart of the development management system 10 is the engine. Using the data that have been harvested from project artifacts, the development management system 10 engine applies sophisticated algorithms to provide real-time information about: 1) the velocity of the project; 2) the productivity of the software engineering team; 3) the complexity of software development; 4) the productivity of the Quality Assurance team; 5) recommendations for code analysis and recapturing; 6) recommendations for defect remediation; and 7) recommendations to improve development team productivity, and the like.

The development management system 10 uses sophisticated algorithms to analyze the metrics. Computer science and experience have shown that traditional regression based algorithms are poor predictors of software development success. Regression models are prone to providing misleading information as to cause and effect. Accordingly, the development management system 10 uses “causal modeling.” Causal modeling (Bayesian nets, for example) provide more accurate predictions and modeling of project velocity and risks.

The mathematical form of the algorithm is:

$$\frac{\sum \underline{w} Q * cc}{( \sum w ) * Acc} = D ( \text{Amount of Work computed on Project} )$$

Another form is: (Σ((w)*Q*cc)/((Σw)*Acc)
Where:
w=user defined weight of metric, between −100 and 100
Acc=Average Cyclomatic Complexity for total calculation
Q=Measured Quantity of metric
cc=Cyclomatic Complexity for the Class being measured
   This algorithm is calculated at various time intervals during the project using the metrics produced by the development management system 10 engine described above.

Whenever code is checked into a Configuration Management System like Concurrent Versions System (CVS), a message is sent to the development management system 10 engine. The development management system 10 engine then harvests a complete list of metrics from the source code of the product being examined by the development management system engine. Those metrics are then processed by the algorithm to produce the quantity D. This is the normalized distance completed by the project on a course towards completion.

Project Velocity is then calculated using:
Velocity=(D2−D1)/(T2−T1)
Where:
D2 and D1 are the results of the formula based on the data sampled at times t2 and t1

The development management system 10 engine produces metrics, trends, and analysis. These data can be visualized and interpreted in several ways, as will now be described.

Architecturally, the development management system 10 builds a “view model.” This model allows great flexibility in the display of information.

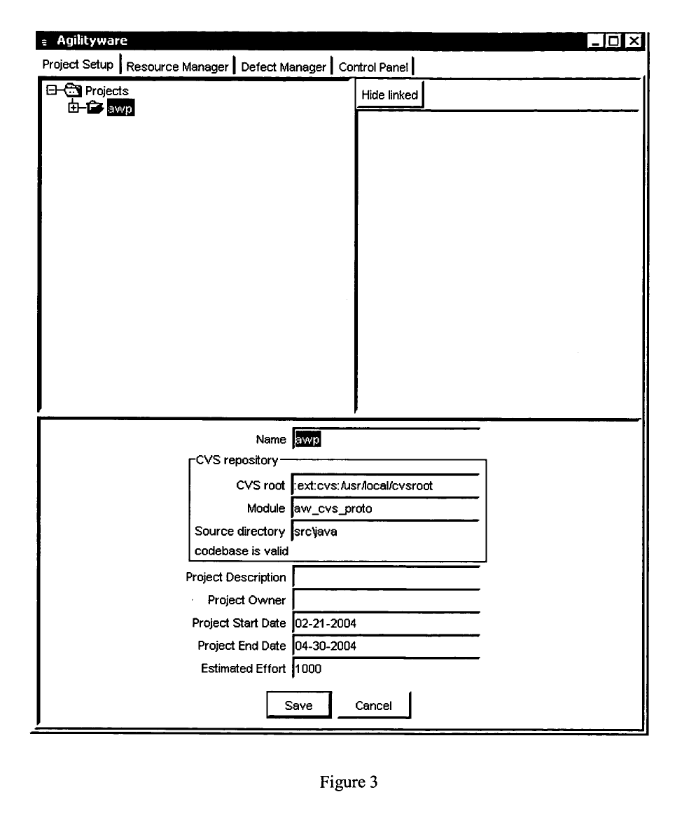

The operation of the development management system 10 engine will now be described. FIG. 3 illustrates a “Project Setup” screen showing the information needed to create a new project. The fields are:
Name: the name of the Project
CVS Root: path to the CVS repository
Module: the highest level object in the CVS repository
Source Directory: the directory name within CVS which contains the Java Source Files
Project Description: a short description of the Project
Project Owner: name of the Project Owner
Project Start Date: date upon which coding on the Project began
Project End Date: targeted date for completion of coding on the Project
Estimated Effort: targeted budget in man-hours to complete the coding for the Project

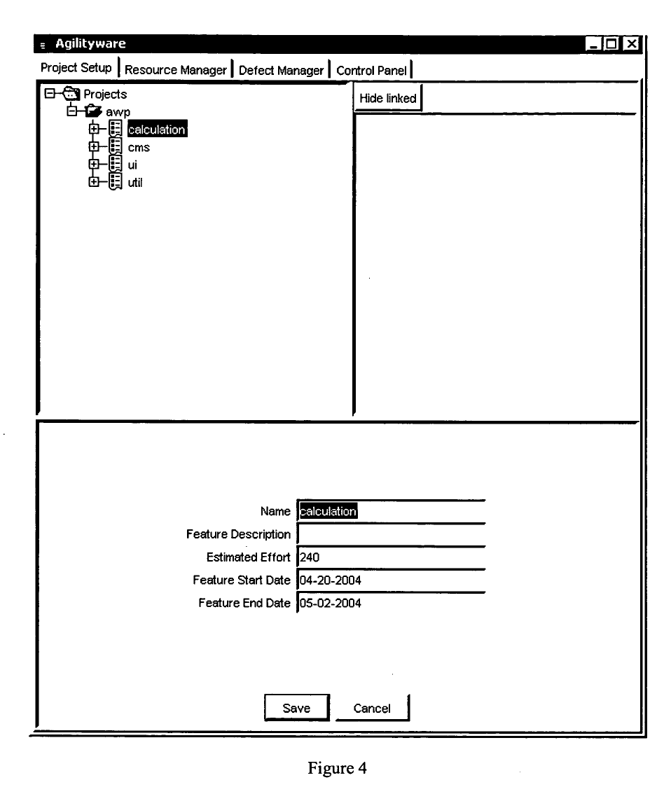

FIG. 4 illustrates an “Edit Features” screen showing how features are edited by the development management system 10 engine. Fields are:
Name: name of the Feature
Feature Description: short description of the Feature
Estimated Effort: budget, in time, to complete coding for the Feature
Feature Start Date: date, determined from the CVS history file, upon which work on the Feature began
Feature End Date: date, determined from the CVS history file, upon which work on the Feature was completed

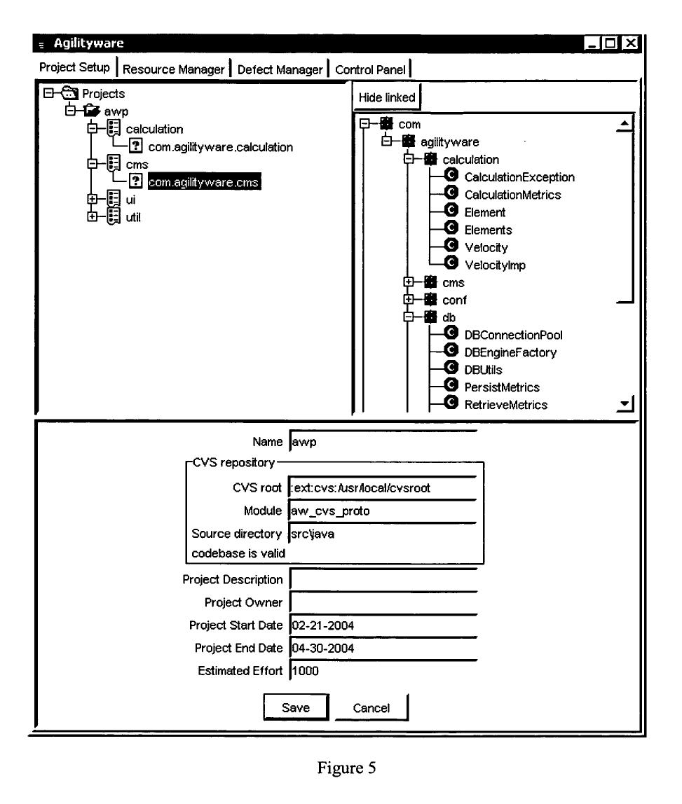

FIG. 5 illustrates a “Code Tree” screen. This screen shows on the left hand pane the code tree feature of the development management system 10 engine. This code tree is retrieved from a CVS folder according to information derived from the screen shown in FIG. 3.

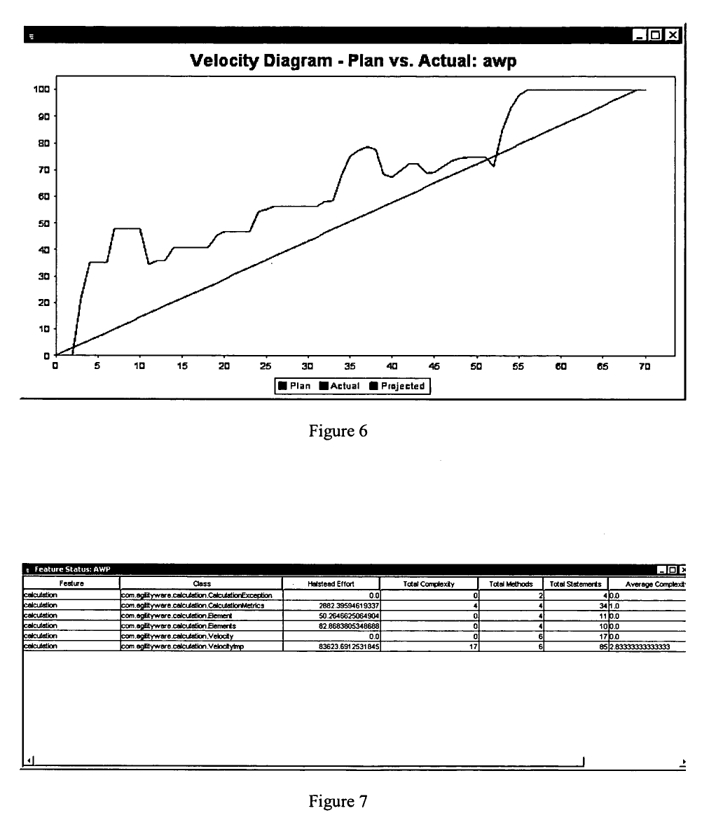

FIG. 6 is a screen illustrating a “Velocity Diagram.” This screen shows the velocity of a project along a path towards success. The top line is the calculated work along a time line. The bottom line represents the targeted completion curve as determined when the project was set up. This graph shows a project that has been consistently ahead of schedule.

FIG. 7 is a screen showing a “Metrics Table.” This table displays a list of metrics when the user clicks on the Velocity Graph shown in FIG. 6.

The development management system 10 reasoning engine also preferably provides possible remediation paths to correct the variance. For example, the development management system 10 identifies a class that has exceeded boundaries for depth in the inheritance tree, for cyclomatic complexity, and is related to a defect with a level four severity. The development management system 10 graphically displays a representation of the code module and all of the modules that are related to that module. A list of engineers responsible for the code may be displayed if the user has so configured the software. With this information, the project team can take immediate action to resolve the problem.

In summary, businesses have struggled for decades to deliver software on time and within budget with very little success. The fundamental cause for this is the lack of an objective, real-time view into their software development process.

The science of software metrics has provided an empirical approach of measuring the quality and maintainability of software development. This science has recently matured to the point where it can be leveraged by the development management system 10 through combining software metrics with causal modeling to accurately predict the status and velocity of software development in real time.

The development management system 10 harvests the artifacts of software development and produces software metrics to provide a window of visibility into the black box of software development and to provide software engineering teams with new tools to understand, manage, and deliver quality software with significant savings in time and effort.

While the foregoing description has been with reference to particular embodiments of the present invention, it will be appreciated by those skilled in the art that changes in these embodiments may be made without departing from the principles and spirit of the invention. Accordingly, the scope of the present invention can only be ascertained with reference to the appended claims.

1. A method for identifying project velocity and status through predictive metrics, comprising the steps of:
harvesting artifacts produced during a software development project;
examining data sources created during development;
measuring artifacts produced during a software development project to produce metrics;
projecting the current velocity and status of a project in real time using an expert reasoning system based on causal modeling; and
generating a project velocity view by plotting the sum of the measurement of a set of objective software metrics deduced from the artifacts over time;
thereby to provide visibility into the real-time progress and status of the project.

2. The method of claim 1 wherein the step of measuring artifacts produced during a software development project to provide metrics comprises taking detailed and empirically sound measurements of the source code, changes being made in the code, defect measurements, and productivity measurements to build a highly accurate measurement of a project's velocity.

3. The method of claim 1 wherein the artifacts comprise configuration management systems (like CVS and ClearCase), defect management systems (like Bugzilla), project management systems (like Microsoft Project), and source code for the software.

4. The method of claim 1 wherein the measured metrics are object oriented metrics.

5. The method of claim 4 wherein the metrics comprise at least one metric selected from among the group of metrics consisting of McCabe's cyclomatic complexity, Halstead metrics, depth of inheritance tree, code fan-in and fan-out, lack of cohesion of methods, response for a class, number of children, defect inflow, and defect recidivism.

6. The method of claim 5 wherein the Halstead metrics comprise program length and programming error.

7. The method of claim 1, further comprising the step of pinpointing what specific code, what defects, which engineers, and what processes are causing a project to deviate from the planned completion date.

8. The method of claim 7, further comprising the step of suggesting remediation tasks to bring the project back on track.

9. The method of claim 1, further comprising the step of predicting early in the development cycle if the project is viable.

10. The method of claim 9 wherein the viability is predicted with great accuracy.

11. The method of claim 1, further comprising the step of predicting actual costs and schedule.

12. The method of claim 1, further comprising the step of estimating the expected completion date of the project.

13. A system for identifying project velocity and status through predictive metrics, comprising:
an application program interface for harvesting data;
an engine for analyzing the data to produce metrics; and
a visualization interface/display means for presenting project velocity information.

14. A system for identifying project velocity and status through predictive metrics, comprising:
means for harvesting artifacts produced during a software development project;
means for examining data sources created during development;
means for measuring artifacts produced during a software development project to produce metrics;
means for projecting the current velocity and status of a project in real time using an expert reasoning system based on causal modeling; and
means for generating a project velocity view by plotting the sum of the measurement of a set of objective software metrics deduced from the artifacts over time;
whereby visibility into the real-time progress and status of the project is provided.
